(19) United States
(12) Patent Application Publication
(10) Pub. No.: US 2011/0313948 A1
(43) Pub. Date: Dec. 22, 2011

(54) SYSTEM AND METHOD FOR SEARCHING UNDERLYING HOLDINGS IN INVESTMENT FUNDS

(75) Inventors: George W. Hagerman, Denver, CO (US); Matthew Crooks, Littleton, CO (US); Kevin Sun, Highlands Ranch, CO (US)

(73) Assignee: CACHEMATRIX TECHNOLOGY SERVICES, LLC, Denver, CO (US)

(21) Appl. No.: 13/178,549

(22) Filed: Jul. 8, 2011

Related U.S. Application Data
(63) Continuation-in-part of application No. 11/071,064, filed on Mar. 3, 2005, now Pat. No. 7,983,969.

(51) Int. Cl. G06Q 40/00

(52) U.S. Cl. 705/36 R

(57) ABSTRACT

A system and method associated with investment funds provide institutional and individual investors with comprehensive on-line analysis, account management, on-line money market trading capabilities, and ability to search particular holdings in funds associated with the user account or funds available for purchase by a financial institution. The system and method allow investors to log on, check account balances, transfer funds within accounts and from outside accounts, research money market investments, purchase, redeem and exchange shares of money market funds, and search particular holdings in funds owned by the user or available for purchase by the financial institution.

### CROSS-REFERENCE TO RELATED APPLICATION

This application is a continuation-in-part of U.S. patent application Ser. No. 11/071,064 filed Mar. 3, 2005 and titled Money Market Trading Platform, the disclosure of which is expressly incorporated by reference herein in its entirety.

### TECHNICAL FIELD

This disclosure relates to trading platforms for institutional and individual investors, and more particularly to systems and methods for managing, analyzing, and searching information relating to money market trading platforms and other investment funds.

### BACKGROUND

Institutional investors are investors that trade on behalf of institutional clients such as corporations, labor unions, retirement funds, and college savings or 529 plans. The trading habits and needs of institutional investors are quite different from the trading habits and needs of individual investors. For example, institutional investors generally manage large sums of money, and consequently daily purchase and redeem millions and tens of millions of dollars worth of money market funds. Similarly, institutional investors are often active market participants, and possess expert knowledge about the markets in which they trade. They often use that knowledge to capitalize on breaking news that effects market valuations and performance. Given the size and volume of their daily trading activity, settling the accounts of institutional investors often requires regular transfers of large amounts of cash. This is usually done via an electronic fund or wire transfer, and separate wire transfers are generally required every time a fund is purchased. Thus, when several fund purchases are made throughout a trading day, several wire transfers are required to settle those purchase transactions. Institutional investors are also subject to regulatory restrictions not placed on ordinary investors, which put limits on how institutional investors can invest their funds. As a result, they often need to know certain information that non-institutional investors do not need to know. For example, to ensure compliance with self-regulatory rules, institutional investors often need to know the relative size of the positions they take in given money market funds. While securities trading systems are known in the art, none are generally designed to provide the types of information and functionality that are needed by institutional investors, and particularly by institutional investors who trade in money market funds.

Similarly, with respect to mutual funds or other types of investments that are a collection of one or more securities (e.g., stocks, bonds, and other types of financial instruments), investors (either institutional or individual) research and analyze those investments in consideration of many factors as discussed above. For a number of reasons, investors in financial products, including mutual fund product offerings, may analyze the underlying holdings constituting the fund owned by the investor or analyze a fund the investor may add to the account or portfolio. This analysis could be for research purposes, risk mitigation analysis, trading compliance regulations, or any other reason. In addition to understanding the holdings of the fund at a high level, the investor may need to associate the individual exposure to the underlying fund holdings based upon the current asset levels in the various funds based upon their own portfolio holdings.

For example, a particular mutual fund may have a multitude of holdings, including stocks, bonds, and other securities. Typically this information is not available to investors until the financial institution creating the fund releases the information in the form of disclosure documents required by trading compliance rules and regulations. If an investor seeks to determine the underlying holdings of a mutual fund that is part of a investment portfolio owned or managed by the investor, the investor may not have accurate information as the mutual fund may be constituted differently than the disclosure documents released by the financial institution creating the fund. This delay disadvantages the investor or person analyzing the portfolio, who may want to have a more recent picture of the investment fund and make decisions on risk management or how to maximize the investment by allocating resources in the portfolio as a whole based upon the holdings making up the fund.

Moreover, the information released by the financial institution creating the fund may not be in a format that is suitable for investors to use the information efficiently. To this end, there is a need for rapid searching and analysis of underlying holdings in an investment fund.

### SUMMARY

A money market trading platform implemented as a computer program running on a computer is configured to deliver information to an institutional money market investor. The information delivered to the investor may include one or more of the following: the percentage of a money market fund that is owned by the institutional investor, a daily sub total of the purchases made by the institutional investor that require settlement, or the names of first and second money market funds between which the institutional investor can exchange money or funds.

In one aspect, the money market trading platform provides a method for aggregating a plurality of money market purchases made by an institutional investor in the course of a trading day. The method involves receiving a plurality of requests to purchase one or more money market funds; determining the amount needed to make each purchase in each of the plurality of requests, and adding the amount to a daily purchase sub-total. At the end of the trading day, the institutional investor can settle his or her account in a single transaction, e.g., by making a single wire-transfer payment in the amount of the daily purchase sub-total.

In another aspect, the money market trading platform provides a method for determining the percentage of a money market fund that is owned by an institutional investor. The method involves receiving a number representing the current assets under management for a money market fund in which the institutional investor has a position; receiving a number representing the current amount of money the institutional investor has invested in the money market fund; and dividing the number representing the current amount the institutional investor has invested in the money market fund by the number representing the current assets under management for the money market fund.

In another aspect, the money market trading platform provides a method for allowing an institutional investor to exchange shares held in money market funds. The method involves receiving a request from an institutional investor to exchange shares in a first money market fund for shares in a second money market fund, and verifying that the investor has enough invested in the first money market fund to cover the amount sought to be purchased in the second money market fund. Upon verifying that the investor has enough vested in the first money market fund, the method involves redeeming the requested amount in the first money market fund, and using the proceeds to purchase the same amount in the second money market fund.

In one aspect, a computer program product, stored on a non-transitory machine readable medium, provides instructions to cause a microprocessor to search one or more holdings associated with one or more investment funds of a user account. The instructions includes the steps of receiving an electronic representation of one or more keywords and searching the one or more investment funds associated with the user account to determine the one or more holdings that contain the one or more keywords. The steps also include sending results, indicating one or more holdings associated with the one or more investment funds containing the one or more keywords, to at least one device associated with the user account.

In one aspect, a system for searching holdings in one or more investment funds associated with a user account includes means for receiving an electronic representation of one or more keywords and means for searching the one or more investment funds associated with the user account to determine the one or more holdings that contain the one or more keywords. The system may also include means for sending results, indicating one or more holdings associated with the one or more investment funds containing the one or more keywords, to at least one device associated with the user account.

In one aspect, a system for searching one or more holdings in one or more investment funds associated with a user account includes a fund system, accessible by one or more client devices, wherein the fund system includes a microprocessor and a database electronically connected to the fund system. In addition, the system may include a microprocessor that is configured to run a computer program, stored in a non-transitory computer-readable storage medium, that instructs the microprocessor to access information resident in the database associated with the user account and send information to the one or more client devices regarding holdings of the user account associated with one or more keywords received from the at least one client device.

In one aspect, a system for searching one or more holdings in one or more investment funds available from an investment bank and accessible by a user includes a fund system, accessible by one or more client devices, wherein the fund system includes a microprocessor; and a database electronically connected to said fund system. The system may include a microprocessor that is configured to run a computer program, stored in a non-transitory computer-readable storage medium, that instructs the microprocessor to access information resident in the database associated with the one or more investment funds and send information to the one or more client devices regarding holdings of the one or more investment funds.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a flow chart depicting a method for determining the percentage of a money market fund that is owned by an institutional investor.

FIG. 2 is a flow chart depicting a method for aggregating the money market purchases of an institutional investor, thereby allowing the investor to settle his or her account a single time for the aggregate purchase amount.

FIG. 3 is a flow chart depicting a method for allowing an institutional investor to exchange money market funds.

FIG. 4 is a screen shot showing an “Account” details section of one embodiment of the trading platform.

FIG. 5 is a screen shot showing a “Fund” comparison section of one embodiment of the trading platform.

FIG. 6 is a screen shot showing a “Trading” funds section of one embodiment of the trading platform.

FIG. 7 is an exemplary system for searching underlying holdings of investment funds associated with a user account or available from a financial institution.

FIG. 8 is an exemplary flowchart illustrating a method for searching underlying holdings of a user account.

FIG. 9 is an exemplary representation of an electronic sheet illustrating information associated with searching underlying holdings of a user account.

FIG. 10 is an exemplary representation of an electronic sheet illustrating certain details of a user account.

FIG. 11 is an exemplary flowchart illustrating a method for searching underlying holdings of an investment fund available from a financial institution.

FIG. 12 is an exemplary representation of an electronic sheet illustrating information associated with searching underlying holdings of investment funds available from a financial institution.

Like reference symbols in the various drawings indicate like elements.

### DETAILED DESCRIPTION

A money market trading platform provides institutional investors with comprehensive on-line analysis, account management, and on-line money market trading capabilities. It also allows institutional investors to exchange or transfer money from one money market fund to another. In one embodiment, an institutional investor's computer workstation is connected via the Internet or other communication network to a bank or broker's computer system. The bank or broker's computer system is in turn connected through the Internet or other communication network to one or more money market funds or money market trading systems. The bank or broker maintains an omnibus account for placing trades with the one or more money market funds or money market trading systems, and maintains information about each institutional investor, and information about each investor's accounts on its computer or computer system.

In one aspect, the trading platform allows an institutional investor or user to log onto the trading platform with a unique user identifier (“user ID”) and password. Once logged on, the user can check account balances, transfer funds from outside accounts (e.g., via wire transfer), research potential money market investments, and purchase, redeem and exchange shares of money market funds. In one embodiment, the money market activities, transactions, and other functionality available to the user or institutional investor are suitably displayed or made accessible via a graphical user interface. The interface allows the user to view interrelationships between financial information and financial operations, and thereby facilitates analysis and financial transactions that are based, at least in part, on viewing the financial information and operational interrelationships.

Once logged-on, the trading platform provides useful account information to users (institutional investors). The account information includes the names and numbers of all of the accounts that are owned by the user, and the balance of the portfolio managed by the user (i.e., the sum of all of the money that is held in all of the user's accounts). For example, the trading platform can provide information indicating that an institutional investor has two accounts worth a total of approximately $795 million dollars—a pension fund account worth approximately $545 million dollars and a self-insurance account worth approximately $250 million dollars. In one aspect, for each of the investors accounts, the trading platform displays the date the account was opened, a portion of the tax identification number associated with the account, the names of all of the money market funds in which positions are held, the amount of money held in each money market fund, and the total amount of money held in the account.

In an exemplary embodiment, the trading platform allows institutional investors to research and purchase money market funds. Funds can be researched by displaying all of the funds available for purchase through the bank or broker, or by displaying only those funds that satisfy certain filter criteria. Displayed funds are generally displayed together with the criteria that are used to filter the funds. These criteria can include the names of the funds, their ticker symbols, their CUSIP identifiers, the total assets under management (“AUM”) for the fund, the current amount of the fund that is owned by the user (e.g., in both absolute terms and as a percentage of AUM), the 1-day, 7-day, and 30-day fund yields, various fund ratings (e.g., Moody's, S&P, Fitch & NAIC), the type of fund (e.g., prime, municipal or treasury), the fund's date of inception, expense ratio, etcetera. Displayed funds can generally be sorted by the filter criteria. For example, the funds can be sorted in ascending or descending order to show which funds have the highest or lowest 7-day effective yield.

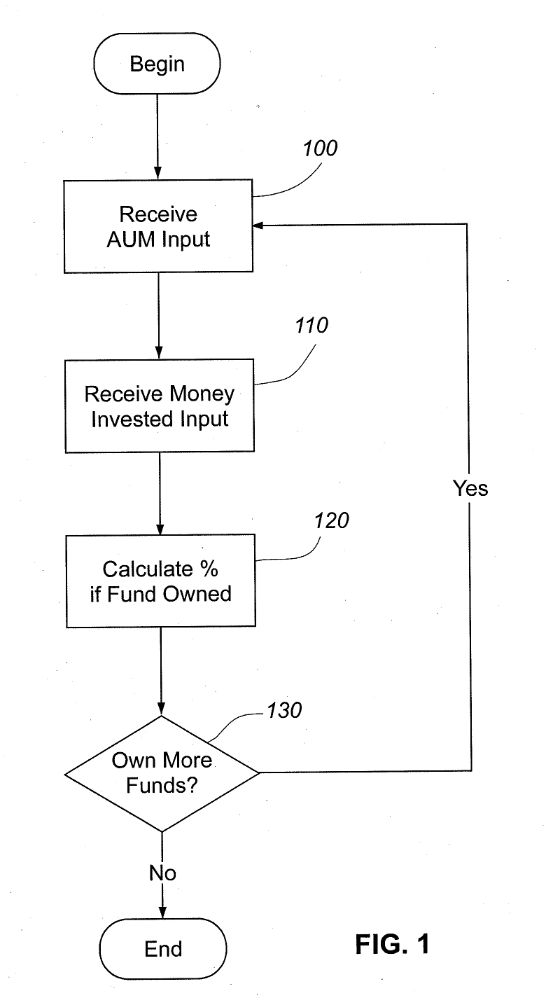

In one aspect, among the information the trading platform can display to a user or institutional investor is the percentage of each fund that is owned by that investor. The trading platform determines this percentage as shown in FIG. 1. On a periodic basis, which is typically daily, the trading platform receives input from each money market fund that can be traded indicating the total assets that fund currently has under management. This information can be stored in a database that is associated with the trading platform, or it can be retrieved whenever an institutional investor requests a display of the percentage of funds owned. The trading platform determines the percentage of each fund owned by receiving input for each fund indicating that fund's current assets under management (step 100) and the amount of money the investor currently has invested in the fund (step 110). After determining the current assets under management and the amount the investor has invested in a fund, the platform determines the percentage of the fund owned by dividing the amount invested by the assets under management (step 120). The trading platform calculates and displays this percentage for each money market fund that is owned by the investor (step 130). When the investor maintains multiple accounts, the trading platform determines the percentage of fund owned for each of the investor's accounts. By determining and displaying the percentage of funds owned, the trading platform provides institutional investors with the needed means to monitor and ensure compliance with applicable regulatory rules, such as self-regulatory rules.

In an exemplary embodiment, the trading platform allows institutional investors to trade shares in one or more of the available money market funds by placing orders to purchase, redeem, or exchange shares. The orders can be placed, for example, by selecting an item in a drop down transaction menu that appears next to each fund's name. When the investor elects to redeem fund shares, the trading platform provides a text box, drop down menu, or other similar means for the investor to indicate the dollar amount that the investor wishes to redeem. The trading platform may provide a text box, drop down menu or other suitable means to allow the investor to identify the bank account to which the investor wishes the redemption proceeds to be deposited.

For example, when the investor elects to purchase shares, the trading platform provides a text box, drop down menu or other means for the investor to indicate the dollar amount of the fund that the investor wishes to purchase. The trading platform allows an investor to make multiple fund purchases over the course of a trading day, and to aggregate those purchases so that the investor can settle his or her account a single time at the end of the trading day via a single wire transfer.

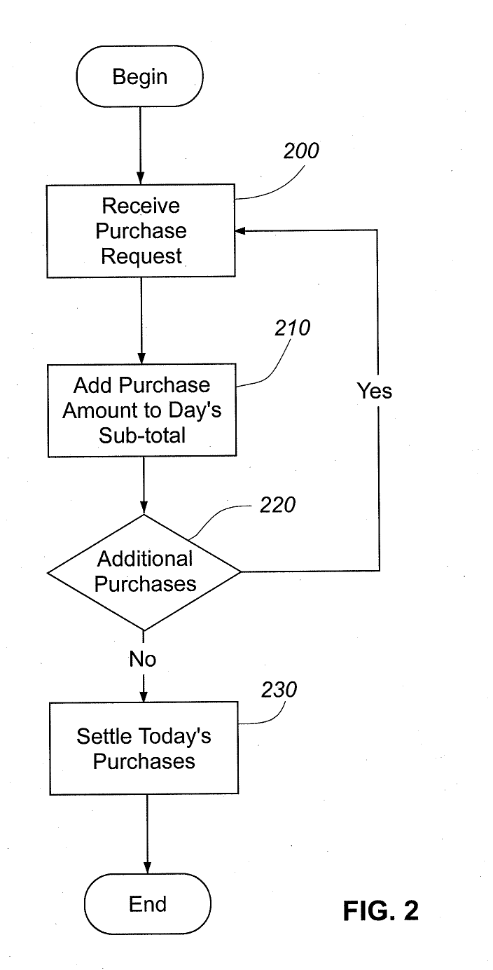

In one embodiment, as shown in FIG. 2, when the trading platform receives a purchase request (step 200), it adds the current purchase amount to a daily purchase sub-total (step 210). If additional purchases are made throughout the day (step 220), the trading platform receives those additional purchase requests (step 200), and adds the additional purchase amounts to the daily purchase sub total (step 210). As a result, at the end of the trading day, the trading platform can determine the amount needed to settle the institutional investors account (step 230). This allows an institutional investor to settle his or her account in a single transaction, by ordering a single wire transfer in the amount of the final daily purchase sub-total, while making one or more purchases from one or more mutual funds throughout the trading day.

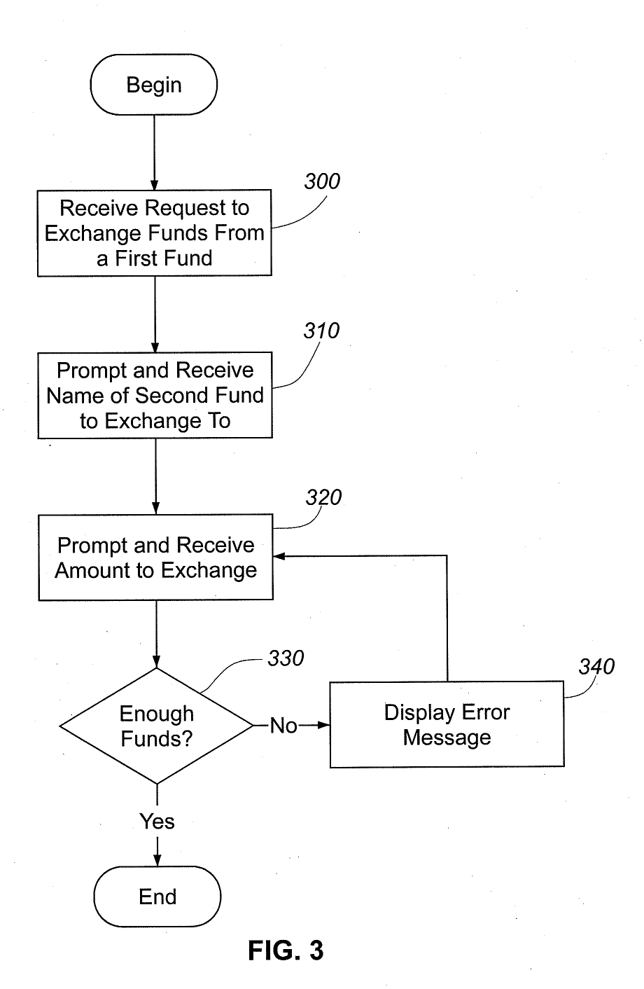

In one aspect, the trading platform, may allow an institutional investor to exchange funds from one money market fund to another money market fund without depositing additional funds into his or her account. For example, as shown in an embodiment depicted in FIG. 3, the trading platform is configured to receive an investor request to exchange funds from a first money market fund (step 300). Upon receiving the request, the trading platform provides the investor with a text box, drop down menu or other means to indicate the name of a second money market fund in which the investor wishes to take a position by exchanging shares from the first money market fund (step 310). The trading platform then provides the investor with a text box, drop down menu or other means to indicate the dollar amount of funds that the investor wishes to exchange from the first money market fund to the second money market fund (step 320). Next, the trading platform verifies that the investor has a large enough position in the first money market fund to allow the desired exchange from the first money market fund to the second money market fund (step 330). If the first money market fund does not have sufficient funds, an error message is displayed (step 340), and the user is again prompted to enter a new dollar amount (step 320). When the investor enters a dollar amount that can be covered by the investor's position in the first money market fund, the trading platform completes the exchange of funds from the first money market fund to the second money market fund, without requiring a deposit of additional funds into the investor's account.

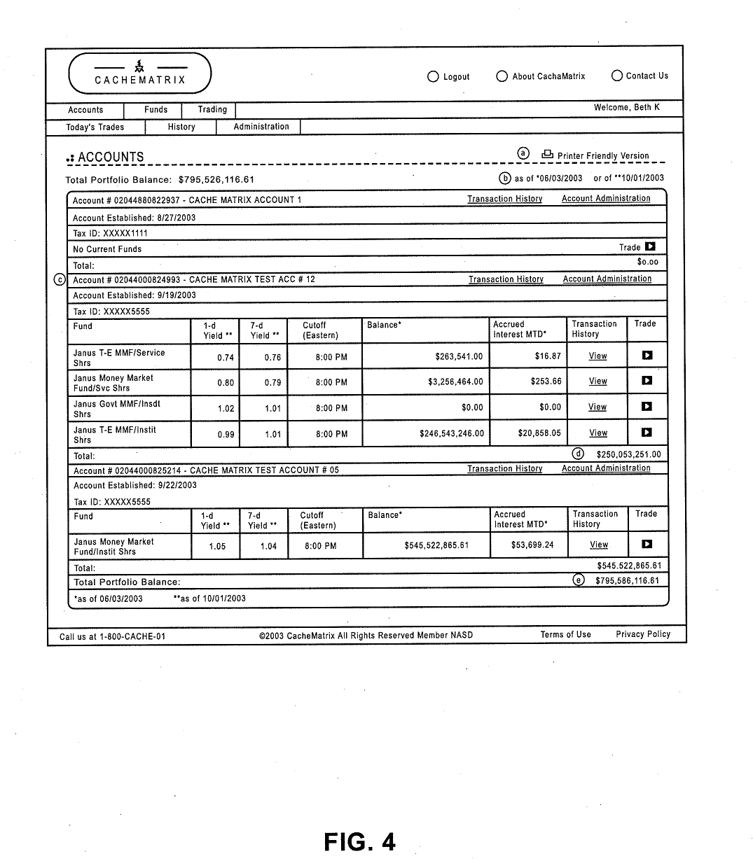

Each of the exemplary features of the money market trading platform described herein are accessible through interrelated areas that are displayed together or in a logical fashion as a web of linked documents. In one embodiment, each feature is available in a document that can be displayed to an institutional investor via a web browser or other suitable graphical user interface. For example, as shown in FIG. 4, the trading platform can display user account information such as the number and type of accounts, the holdings and total value of each account, and the total holdings in all accounts to an institutional investor that successfully logs-on to the trading platform. From the user account page, the institutional investor can administer his or her account through the “Administration” tab, review that days transactions through the “Today's Trades” tab, review even more transaction history through the “History” tab, search money market funds through the “Funds” tab, or trade funds through the “Trading” tab.

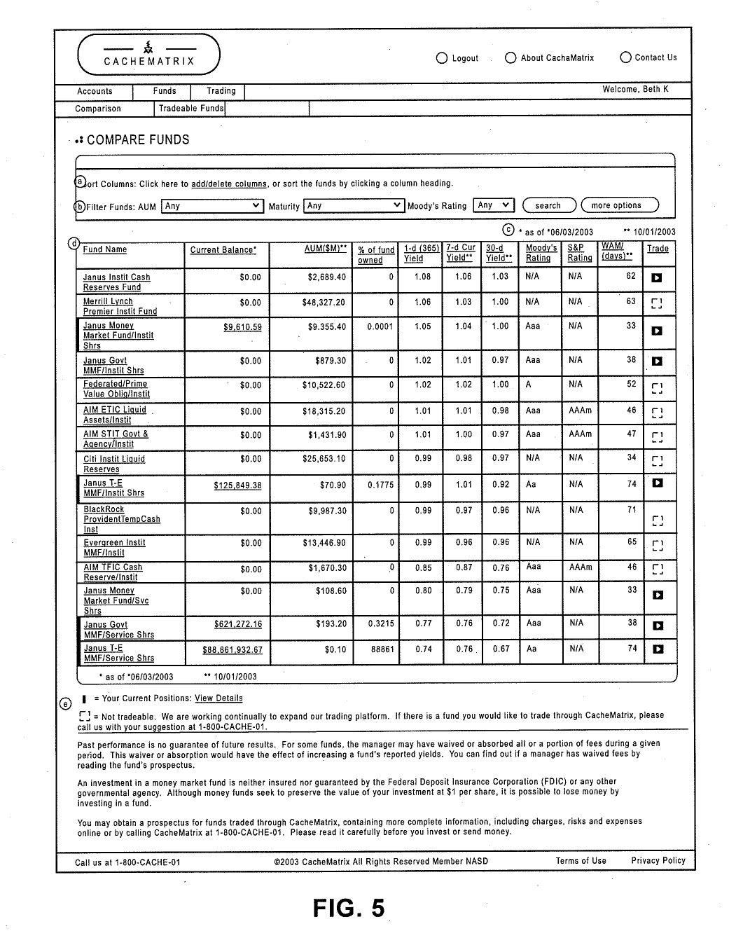

As shown in FIG. 5, the trading platform allows an institutional investor to research all of the funds that are available for trading by selecting the “Funds” tab. When the “Funds” tab is selected, various information such as the money market fund name, current assets under management, and 1-day and 7-day yields are displayed. The institutional investor can customize the type of information that is displayed by adding or deleting columns of information. The institutional investor can also use the information that is displayed to filter, find, and display only those money market funds that are of interest to him or her. For example, the institutional investor can filter, find and display only those funds that are rated AAA by Moody's and that have more than $5 billion dollars in assets under management. From the “Funds” tab, the institutional investor can return to the “Accounts” tab to display all account information, or can select the “Trading” tab to purchase, redeem, or exchange money market funds.

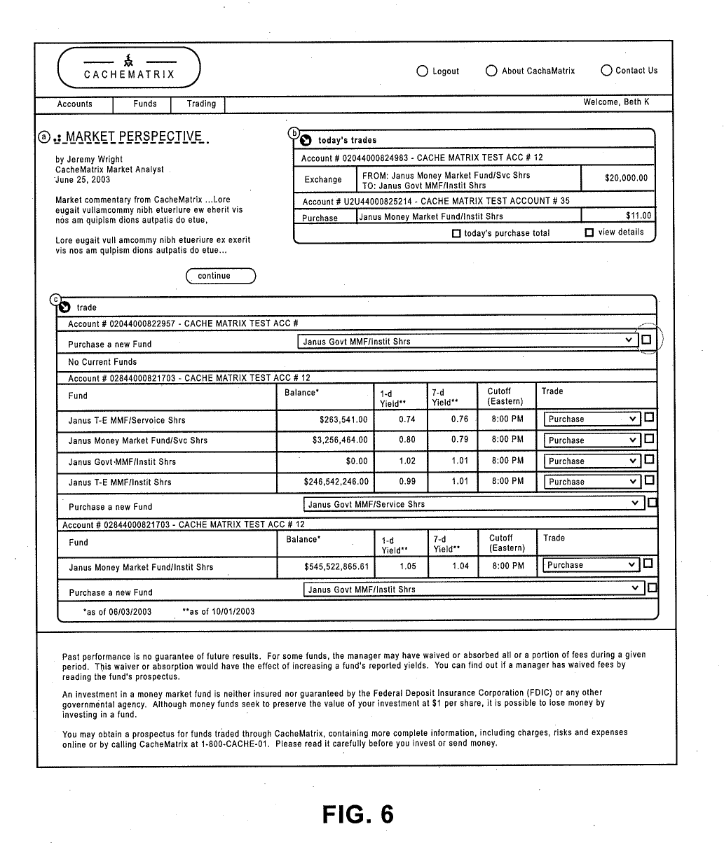

For example, as shown in FIG. 6, upon selecting the “Trading” tab, the institutional investor is presented with a summary of the day's trading activity, a drop down menu that allows the institutional investor to purchase a money market fund from a list of funds, and a list of account holdings. The list of account holdings includes a drop down menu that allows the institutional investor to alter his or her current account positions by purchasing, redeeming or exchanging those money market funds in which the institutional investor currently holds a position. For example, the institutional investor can add to a fund position by purchasing additional money market funds or can liquidate a fund position by redeeming all of the shares held in that money market fund. Upon purchasing additional money market funds, the trading platform displays a pop-up menu that shows the current daily purchase sub-total. By running and displaying a daily purchase sub-total, the trading platform allows the institutional investor to settle the days current trading activity by making a single wire transfer payment in the amount of the daily purchase sub-total as explained above with respect to FIG. 2.

The trading platform of the present disclosure may be implemented on a bank or broker's computer or computer system. The bank or broker will generally maintain an omnibus account with one or more money market funds or money market trading systems to give the bank or broker's institutional investor clients access to the money market funds that are offered through the trading portal. When an institutional investor buys or redeems shares of a money market fund through the trading portal, the bank or broker purchases or redeems shares of that money market fund on behalf of the institutional investor by placing appropriate orders through its omnibus account. Because all money market fund purchases, redemptions and exchanges entered by institutional investor's through the trading portal are ultimately placed through the bank or broker's omnibus account, the bank or broker can net-out or conglomerate all of the orders placed by its institutional investor clients to each money market fund that is available for trading, and make a single or net trade with each fund to balance the bank or broker's omnibus account. In this way, the content of the bank or broker's omnibus account will reflect the net holdings of the institutional investor accounts that have access to and trade money market funds through the trading portal.

The trading platform can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The trading platform can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory.

Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the trading platform can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

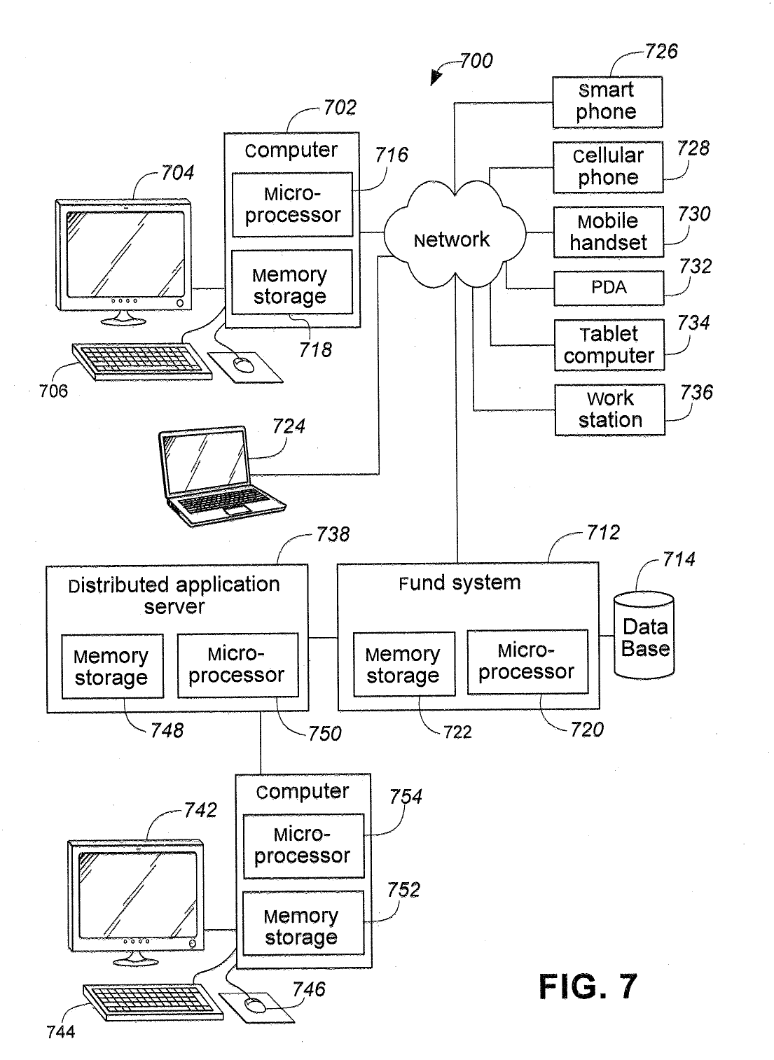

In another aspect of the present disclosure, a user (whether an institutional investor or an individual investor) may review, search, and analyze particular holdings that are part of an investment fund, such as for example, a mutual fund. FIG. 7 illustrates an exemplary system that may be used for implementing the present disclosure.

FIG. 7 depicts a system 700, including a computer 702, a monitor 704, a keyboard 706, and a mouse 708, a network 710, fund system 712, and database 714. Computer 702 includes microprocessor 716 and memory storage 718. Fund system 712 may include microprocessor 720 and memory storage 722.

Additionally, system 700 may include other client devices such a laptop computer 724, a smartphone 726, a cellular phone 728, a mobile handset 730, a personal digital assistant (PDA) 732, a tablet computer 734, workstation 736 or any electronic device allowing a user to interact with fund system 712 either directly or via some type of network connection.

Moreover, system 700 may include a distributed application server 738, a computer 740, a monitor 742, a keyboard 744, and a mouse 746. Distributed application server 738 may also include memory storage 748 and microprocessor 750. Computer 740 may also include memory storage 752 and microprocessor 754. Other electronic devices (such as the laptop, smartphone, cellular phone, mobile handset, PDA, tablet computer, and workstation described above) may also be connected to distributed application server 738.

Generally, computer 702, as well as client devices 724-736, may interact with fund system 712 via network 710. The interactions include data that is sent to and from fund system 712 and computer 702 to allow a user to practice the present disclosure, which will be described in greater detail below. This data may include information entered by a user and information sent from fund system 712 to computer 702 and devices 724-736 requesting additional information from the user or providing results to the user.

The connection between computer 702 and fund system 712 can be accomplished through any type of network that connects electronic devices, including but not limited to the

Internet via an Internet Service Provider, a WAN, a LAN, a wireless communications connection, satellite communications connection, or any combination thereof.

In addition, in one aspect, access to fund system 712 may also be accomplished through a electronic connection to distributed application server 738. In this aspect, distributed application server 738 may have client devices connected thereto (e.g., computer 740) and a user may interact with the fund system 712 and perform operations (described later) consistent with the present disclosure, including the search operations.

Fund system 712 may electronically access a database 706, wherein database 706 may store information relating to financial information regarding accounts of users of the present disclosure.

The present disclosure may be implemented as a computer program product wherein in some or all of the instructions are executed using fund system 712 (via memory storage 722 and/or microprocessor 720), computer 702 (via memory storage 718 and/or microprocessor 716), distributed application server 738 (via memory storage 748 and/or microprocessor 750), devices 724-736, any combination thereof. The steps included as part of the computer program product are discussed in greater detail below.

In addition to system 700, the present disclosure as directed to the search feature may also be included as part of the money market trading platform and/or portal as described above with respect to FIGS. 1-6.

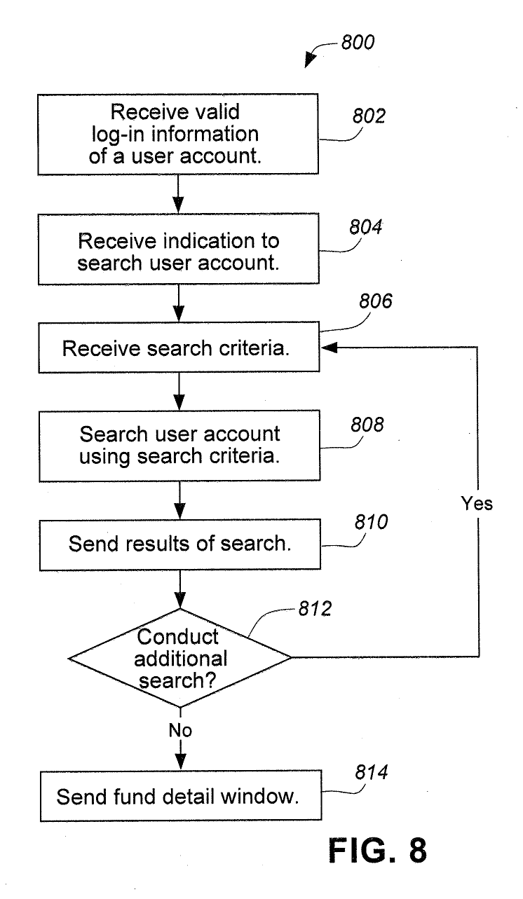

FIG. 8 illustrates a flowchart for a method 800 for searching holdings in a user account or portfolio consistent with the operation of the present disclosure. Method 800 may be carried out using one or more of the devices illustrated in system 700 as discussed below, however, method 800 may be carried out using alternative systems that are consistent with FIG. 7 as well as the trading platform and/or portal as described with respect to FIGS. 1-6.

Method 800 begins at step 802, in which a user's log-in information associated with a user's account or portfolio is received by, for example, fund system 712. The log-in information may include a username and password determined by the user or assigned to the user from system 700 as depicted in FIG. 7 or the money market trading platform and portal described as part of FIGS. 1-6. In one exemplary aspect, a user of computer 702, computer 740, or any of the devices 724-736 may see an indication to enter in the log-in information. Using a suitable input means, such as keyboard 706 and/or mouse 708, the user enters in the information which is transmitted to fund system 712 via network 710 and/or distributed application server 738. Fund system 712 may determine if the log-in information is valid by accessing user account information stored at fund system 712 or stored in database 714. Alternatively, log-in information may be stored in other locations consistent with computer client-server architecture models and principles. If the log-in information is valid, method 800 continues to step 804.

At step 804, the user may provide an indication to search details of funds that are part of one or more accounts that the user may have, and which collectively represent a financial investment portfolio the user has with a particular financial institution. This indication to search may be sent to fund system 712 by any of the methods that have been previously discussed. The search may be performed on one or more accounts associated with the user's portfolio.

Within each account, the user may have one or more funds that collectively make up the account. Each fund, for example a mutual fund, may also comprise underlying holdings. These holdings may include but are not limited to stocks, bonds, and/or other financial ownership interests. An indication to search may mean that the user desires to search a particular type of holding to determine which funds the user has a financial interest in that contain that particular holding. Being able to search this type of information is valuable to a user that may need to analyze the exposure of the user's investment to a particular type of holding and make decisions based upon that exposure.

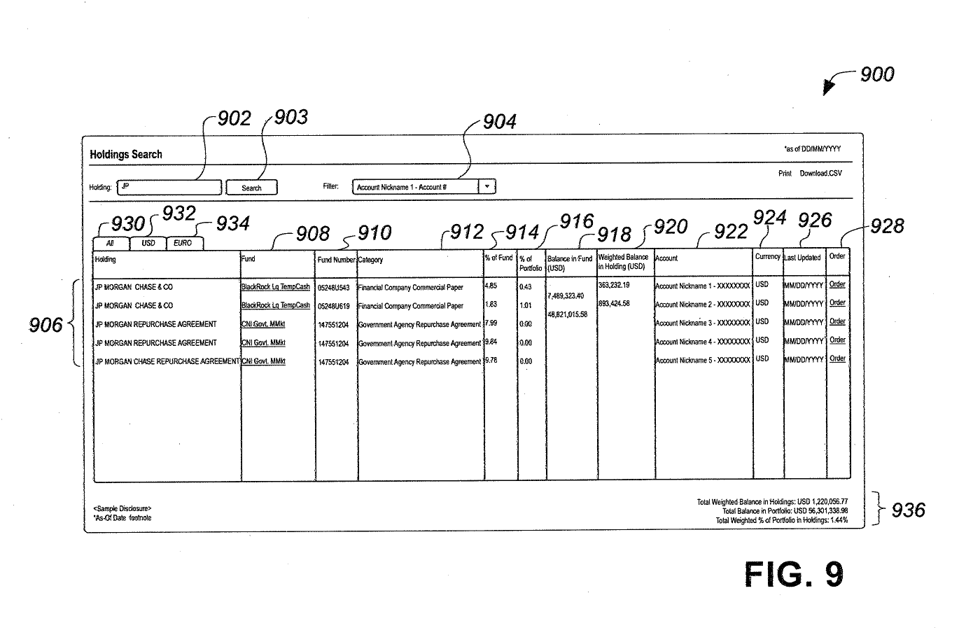

At step 806, after the user indicates that a search should be conducted, the user is provided with electronic search fields in order to enter and/or select information regarding the search criteria. For example, fund system 712 may send information to computer 702 which is displayed to the user via monitor 704 in the form of an electronic sheet containing fields for the user to choose in order to search particular holdings in funds associated with the user account. The user may target the search using keywords and apply the search to particular accounts (see, for example, FIG. 9 discussed in greater detail below). By way of example, the user may enter in the keyword “JP” into a search term field in order to search holdings associated with JP Morgan within mutual funds that are part of an particular account of the user. An example of an electronic sheet 900 displayed to a user having the aforementioned search features is shown in FIG. 9, which will be discussed in greater detail below.

At step 808, after receiving one or more keywords to search, fund system 712 processes the information in order to provide the user a list of results. In order to do this fund system 712 may contain a software product that is executed by microprocessor 720 and may access memory storage 722 and/or database 714 to retrieve data in order to determine the funds that contain the keywords provided by the user.

At step 810, results are sent to the user indicating the funds that contain the keywords. In exemplary embodiment, fund system 712 sends the results to computer 702, which are displayed to the user via monitor 704 in the form of an electronic sheet. An example of the displayed results in the form of an electronic sheet is illustrated in FIG. 9.

At step 812, the user may send an indication that an additional search is desired and that indication is received, for example, by fund system 712. In this case, the user enters keywords as described above and method 800 repeats steps 806, 808, and 810.

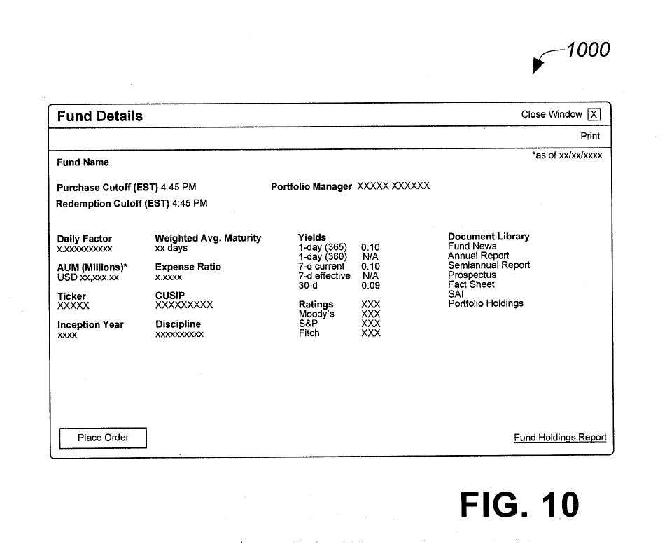

If the user indicates that another search is not desired, at step 814, a fund detail window may be displayed to the user providing certain details regarding the user's account. An example of such a window is illustrated in FIG. 10 and described in greater detail below.

FIG. 9 illustrates an electronic sheet 900, which is an exemplary sheet that is displayed to a user in order to search information relating to holdings in funds associated with a user account. Sheet 900 may be displayed on monitor 704 or any other display mechanisms that are part of the other client devices noted in connection with FIG. 7 and system 700. In one aspect, sheet 900 is also downloadable and/or printable by the user.

Sheet 900 may include different types of information that the user can view and/or enter in order to search holdings in particular funds. Sheet 900, for example, includes search field 902, search button 903, filter field 904, holding column 906, fund column 908, fund number column 910, category column 912, percent of fund column 914, percent of portfolio column 916, balance in fund column 918, weighted balance in holding column 920, account column 922, currency column 924, last update column 926, order column 928, currency tabs 930, 932, and 934, and balance information 936. Additional details of these particular fields are provided below, however, the present disclosure is not limited to these descriptions and those skilled in the art understand that other types of fields and information may be displayed to a user consistent with principles noted herein.

In one aspect, electronic sheet 900 contains search field 902 in which a user can enter one or more keywords. The keywords may be used to search all or a subset of holdings for one or more accounts associated with the user. The format of search field 902 can be any format known by those of ordinary skill in the art, including a free-form text box with a variable length. In addition, restrictions can be made to search field 902 to limit the types of characters that are allowed to be entered. Moreover, the types of searches conducted may require an exact match or a wildcard search, wherein the keyword(s) appear in a portion of the holdings being searched.

In one aspect, after a user enters one or more keywords into search field 902, the user clicks search button 903 using known methods (e.g., mouse 708 depicted in FIG. 7), so that the system (e.g., system 700 and/or fund system 712) receive data representing the keywords to be searched. It should be noted that the present disclosure is not limited to this type of method of entering keywords and submitting the keywords via a search button. Other methods may be used to further the purpose of one or more keywords being received by a system (e.g., system 700 and/or fund system 712) that indicate the keyword(s) a user desires to search among holdings in one or more user accounts.

After the search request, in the form of keywords to search the underlying holdings, has been sent by the user and received by the system (e.g., fund system 712), the keywords are processed in order to determine what holdings contain all or part of the keyword(s) depending upon if an exact match search is conducted or a wildcard search is conducted. After processing (as noted above with regard to method 800), the results are sent to the user. If there are no matches or if the user did not enter valid search criteria, a message indicating this is sent to the user. One example of the results sent to a user is depicted in sheet 900. In this example, a keyword word search of “JP” was requested for all underlying holdings that have “JP” as part of the holding name. The underlying holdings are depicted in holding column 906, which contains five underlying holdings that have JP in the name. Holding column 906 will be discussed in greater detail below.

In one aspect, sheet 900 may contain filter field 904 which indicates the account to be searched with the keyword(s) entered in search field 902. Filter field 904 may have text referencing each of the user's accounts. The text may be a nickname assigned by the user to each of the user's accounts or the text can be assigned by the system indicating, for example, the account number or a concatenated version of the account number or other text the operator of the system deems appropriate.

In one aspect, currency tabs 930, 932, and 934 indicate the underlying holdings associated with a particular type of currency. If selected, tab 932 will display U.S. holdings, tab 934 will display European holdings, and tab 930 will display all holdings.

Holding column 906, as noted above, displays the underlying holdings containing the keywords of the search as noted above. In this example, holding column 906 contains five holdings containing the keyword “JP.” The holdings are specific to a particular fund that may be part of one or more accounts being searched by the user. If desired, filter field 904 may filter the results shown on sheet 900 by displaying only those holdings associated with the chosen account. Sheet 900, as shown, displays results of all holdings containing the keyword “JP” for all accounts associated with the user. Filter field 904 displays “Account Nickname 1—Account #” and if applied to the results on sheet 900, would cause the results to display only those holdings associated with “Account Nickname 1—Account #.”

Certain details regarding the specific fund that each underlying holding is associated with may also have columns in sheet 900. The fund names are indicated in fund column 908. In this example, each of the funds containing the five “JP” holdings are shown. In one aspect, each of the fund names that populate fund column 908 will have a link to a fund details window (similar to FIG. 10). In addition, sheet 900 may also contain fund number column 910 and category column 912. Fund number column 910 indicates an identifier number for each of the funds listed in fund column 908 and category column 912 indicates a brief description or type of security of the holding.

In one aspect, sheet 900 may include columns directed to certain percentages associated with the fund, holding and the user's portfolio. Percent of fund column 914 indicates the percentage the holding represent in the listed fund. For example, in sheet 900, the holding “JP Morgan Chase & Co.” represents 4.85% of the fund “BlackRock Lq TempCash.” In addition, percent of portfolio column may represent the total percentage the user's portfolio (which may include all of the accounts the user has in the system) that is associated with the holding. For example, in sheet 900, the “JP Morgan Chase & Co.” holding in the “BlackRock Lq TernpCash” fund represents 0.43% of the user's entire portfolio in the system.

In one aspect, sheet 900 may include columns directed to certain balances associated with the fund and the holding. Balance in fund column 918 calculates the total balance the user accounts displayed on sheet 900 have in the particular fund. For example, with regard to the “BlackRock Lq TempCash” fund, the user collectively has $7,489,323.40 in this fund and $48,821,015.56 in the fund named “BlackRock Lq TempFund.” In addition, sheet 900 may have weighted balance in holding column 920, which may indicate the total balance a particular user account may have in the holding. For example, in sheet 900, the user account of “Account Nickname 1—XXXXXXXX” has a balance of $363,232.19 in the “JP Morgan Chase & Co.” holding in the “BlackRock Lq TempCash” fund. Also, the user account of “Account Nickname 2 —XXXXXXXX” has a balance of $893,424.58 in the “JP Morgan Chase & Co.” holding in the “BlackRock Lq TempFund.” The figures in weighted balance in holding column 920 are calculated by multiplying the balance in the fund by the amount of balance in the holding.

In one aspect, sheet 900 has account column 922 which indicates the user account associated with the holding. In the example of sheet 900, “JP Morgan Chase & Co.” holding that is part of the “BlackRock Lq TempCash” fund is associated with “Account Nickname 1—XXXXXXXX.”

In one aspect, sheet 900 has currency column 924 which indicates the currency of the holding. In the example of sheet 900, the currency is US dollars (USD) for each of the holdings having “JP” in the name. In addition, sheet 900 may include information regarding the last time information regarding the fund and holding has been updated from information received by the owner or operator of systems consistent with this feature in the present disclosure (e.g., one or more devices shown in system 700).

In one aspect, sheet 900 may have order column 928 which will provide a link for the user to order a particular fund. For example, the term “order” associated with each fund may be a link to another page that allows the user to order the fund.

In one aspect, sheet 900 may also display total balance information such as Total Weighted Balance in Holdings, Total Balance in Portfolio, and Total Weighted % of Portfolio in Holdings. In sheet 900, this is shown in bottom right-hand corner. Total Weighted Balance in Holdings may be a sum of the figures in weighted balance in holding column 920, Total Balance in Portfolio may be the sum of the figures in balance in fund column 918, and Total Weighted % of Portfolio may be the sum of figures in percent of portfolio column 916.

FIG. 10 illustrates a fund detail window 1000. Window 1000 may include details of the user's account that may be presented to the user. These details may be presented to the user at the conclusion of the search process as outlined above or at the conclusion of the process noted below describing a general search of underlying holdings of any fund. In addition, window 1000 may open if the user selects any of the funds in FIG. 9 (e.g. the funds listed in fund column 908). In one aspect, the details that may be provided in Window 1000 include a fund name, a daily factor, assets under management (AUM), a ticker symbol, an inception year of the fund, a weighted avg. maturity, an expense ratio, a CUSIP number, discipline, yields, ratings, a fund tracker button, a current balance, percent owned, a purchase cutoff time, a redemption cutoff time, and a portfolio manager.

The listing of details above is not exhaustive and other details regarding the fund may be included in window 1000. In addition, window 1000 may be printable and downloadable.

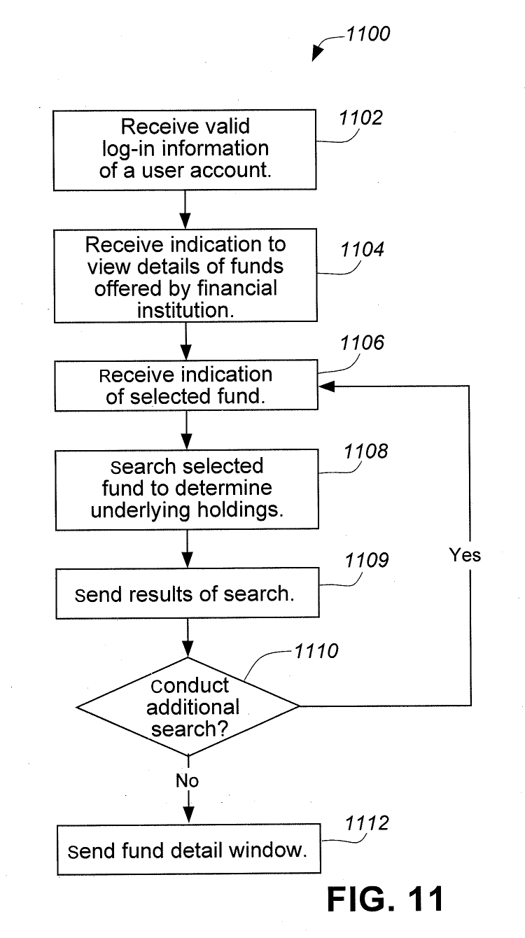

FIG. 11 is a flowchart of a method 1100 for searching underlying holdings of a mutual fund or other investment product consistent with the operation of the present invention. Method 1100 may be carried out using system 700 illustrated in FIG. 7 or the trading platform and/or portal described in connection with FIGS. 1-6.

Method 1100 begins at step 1102, in which a user's log-in information is received by, for example, fund system 712. The log-in information may include a username and password determined by the user or assigned to the user from system 700 as depicted in FIG. 7 or the money market trading platform and portal described as part of FIGS. 1-6. In one exemplary aspect, a user of computer 702, computer 740, or any of the devices 724-736 may see an indication to enter in the log-in information. Using a suitable input means, such as keyboard 706 and/or mouse 708, the user enters in the information which is transmitted to fund system 712 via network 710 and/or distributed application server 738. Fund system 712 may determine if the log-in information is valid by accessing user account information stored at fund system 712 or stored in database 714. Alternatively, log-in information may be stored in other locations consistent with computer client-server architecture models and principles. If the log-in information is valid, method 1100 continues to step 1104.

At step 1104, the user may provide an indication to view details of funds that are available by a particular financial institution. This indication to view may be received by fund system 712 by any of the methods that have been previously discussed. Each fund may comprise one or more types of holdings, for example, stocks, bonds, and/or other types of securities.

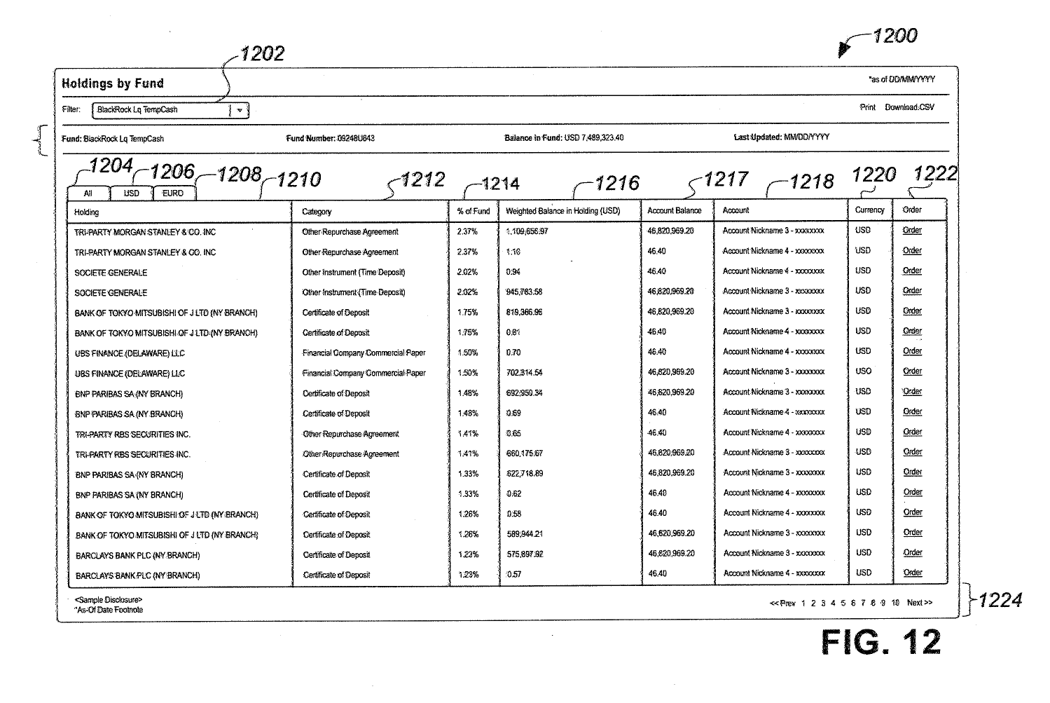

At step 1106, the user selects a particular fund to view and this selection is received by system 700 at, for example, fund system 712. In one aspect, fund system 712 may send information to computer 702 which is displayed to the user via monitor 704 in the form of an electronic sheet containing fields for the user to choose in order to view holdings in a particular fund. For example, a user may want to view the underlying holdings of the mutual fund “BlackRock Lq TempCash.” An example of a screenshot illustrating an electronic sheet 1200 displayed to a user for this feature is shown in FIG. 12, which will be discussed in greater detail below.

At step 1108, after receiving a selection of the fund to view, fund system 712 processes the information in order to provide the user a list of results. In order to do this, fund system 712 may contain a software product that is executed by microprocessor 720 and may access memory storage 722 and/or database 714 to retrieve data in order to determine the holdings constituting the selected fund.

At step 1110, results are sent to the user showing the underlying holdings for the selected fund. In exemplary embodiment, fund system 712 sends the results to computer 702, which are displayed to the user via monitor 704 in the form of an electronic sheet. An example of the displayed results in the form of an electronic sheet is illustrated in FIG. 12.

At step 1112, the user may send an indication that an additional search is desired and that indication is received, for example, by fund server 712. In this case, the user selects a fund as described above and method 1100 repeats steps 1106, 1108, and 1110.

If the user indicates that another search is not desired, at step 1114, a fund detail window, such as window 1000 illustrated in FIG. 10 may be displayed to the user.

FIG. 12 illustrates an exemplary screen shot of electronic sheet 1200 displayed to a user when searching for holdings in a particular fund. Sheet 1200 includes filter field 1202, currency tabs 1204, 1206, and 1208, holding column 1210, category column 1212, percentage of fund column 1214, weighted balance in holding column 1216, account balance column 1217, account column 1218, currency column 1220, order column 1222, and page information 1224.

In one aspect, sheet 1200 may include filter field 1202 which may be a drop-down menu that list the funds available for searching by a user. The user may select one of these funds and this information is received by one or more devices in system 700 (e.g., fund system 700). Based upon the fund that is selected, results appear on sheet 1200 that are associated with the underlying holdings of the selected fund. In one aspect, when a fund is selected additional information may be presented on sheet 1200 including the fund number, a balance that the user may have in fund across all accounts, and the last time the information regarding the fund was updated. In FIG. 12, the balance in fund is $7,489,323.40, which may represent a balance across all accounts in the fund BlackRock Lq TempCash.

In one aspect, currency tabs 1204, 1206, and 1208 indicate the underlying holdings for the selected fund associated with a particular type of currency. If selected, tab 1206 will display U.S. holdings, tab 1208 will display European holdings, and tab 1204 will display all holdings.

Holding column 1210 displays the underlying holdings for the selected fund depending upon the selection of either currency tab 1204, 1206, or 1208. In this example, holding column 1210 contains a number of holdings associated with the “BlackRock Lq TempCash” fund chosen in filter field 1202. Each row of holding column 1210 contains one holding. Category column 1212 displays the type or description of the holding listed in holding column 1210.

In one aspect, sheet 1200 may include columns directed to certain percentages associated with the fund and holding. Percentage of fund column 1214 may indicate the percentage an associated holding has in the fund. Weighted balance in holding column 1216 may indicate the portion of a user's account that is associated with the particular holding. Account balance column 1217 may indicate a balance a user has in a particular account indicated by account column 1218. Sheet 1200 includes account column 1218 that indicates the account that is associated with the particular holding. The account may be a pre-determined nickname or an account name and/or identifying number. To determine the figures in weighted balance in holding column 1216, the balances in account balance column 1217 are multiplied by the percentages in percentage of fund column 1214.

In one aspect, sheet 1200 has currency column 1220 which indicates the currency of the holding. In the example of sheet 1200, the currency is US dollars (USD) for each of the holdings listed in holding column 1210. In addition, sheet 1200 may have order column 1222 which will provide a link for the user to order a particular fund. For example, the term “order” associated with each fund may be a link to another page that allows the user to order the fund.

Sheet 1200 also includes page information 1224 which allows a certain number of holdings per page and the user may view additional pages by selecting various number indicated in page information 1224. Sheet 1200 may also be printable and downloadable by a user.

A number of embodiments have been described. Nevertheless, it will be understood that various modifications may be made without departing from the spirit and scope of the disclosure. For example, the steps of the disclosure can be performed in a different order and still achieve desirable results. While the trading platform was described in terms of a series of linked documents, the available features can be presented in a single viewable area such as in a single viewable document or a single window with multiple window panes. While the trading platform and other systems described herein may have been described as being viewable through a custom graphical user interface, the platform can also be viewable through a convention web browser such as the Internet Explorer or Netscape Navigator web or similar such browsers. Accordingly, these, and other embodiments are within the scope of the following claims.

What is claimed is:

1. A computer program product, stored on a non-transitory machine readable medium, the computer program product having instructions to cause a microprocessor to search one or more holdings associated with one or more investment funds of a user account, said instructions comprising the steps of:
receiving an electronic representation of one or more keywords;
searching the one or more investment funds associated with the user account to determine the one or more holdings that contain the one or more keywords; and
sending results, indicating one or more holdings associated with the one or more investment funds containing the one or more keywords, to at least one device associated with the user account.

2. The computer program product of claim 1, wherein the step of sending results further comprising sending a representation of an electronic sheet including at least one of: a search field, a filter field, a name of one or more holdings having the one or more keywords, a name of one or more investment funds, an identifying number of one or more investment funds, a category of one or more holdings, an indicator of a percentage of one or more holdings in one or more investment funds, an indicator of a percentage of a user portfolio in one or more holdings, an indicator of a balance of the user account in one or more investment funds, an indicator of a weighted balance of the user account in one or more holdings, an account name indicator associated with one or more holdings, and a currency indicator associated with one or more holdings.

3. A system for searching holdings in one or more investment funds associated with a user account, comprising:
means for receiving an electronic representation of one or more keywords;
means for searching the one or more investment funds associated with the user account to determine the one or more holdings that contain the one or more keywords; and
means for sending results, indicating one or more holdings associated with the one or more investment funds containing the one or more keywords, to at least one device associated with the user account.

4. The system of claim 3, further comprising means for storing information associated with the user account.

5. The system of claim 3, further comprising:
means for accessing the user account via a computer network; and
means for receiving the results via the computer network.

6. The system of claim 5, wherein the computer network includes at least one of a WAN, a LAN, Internet, wireless communications connection, satellite communications connection, and distributed application server;
wherein means for receiving the results includes at least one of a computer, laptop, smartphone, cellular phone, mobile handset, personal digital assistant (PDA), tablet computer, and workstation.

7. The system of claim 3, wherein the means for sending results is configured to send a representation of an electronic sheet including at least one of: a search field, a filter field, a name of one or more holdings having the one or more keywords, a name of one or more investment funds, an identifying number of one or more investment funds, a category of the one or more holdings, an indicator of a percentage of one or more holdings in one or more investment funds, an indicator of a percentage of a user portfolio in one or more holdings, an indicator of a balance of the user account in one or more investment funds, an indicator of a weighted balance of the user account in one or more holdings, an account name indicator associated with one or more holdings, and a currency indicator associated with one or more holdings.

8. A system for searching one or more holdings in one or more investment funds associated with a user account, comprising:
a fund system, accessible by one or more client devices, wherein the fund system includes a microprocessor; and
a database electronically connected to said fund system;
wherein the microprocessor is configured to run a computer program, stored in a non-transitory computer-readable storage medium, that instructs the microprocessor to access information resident in the database associated with the user account and send information to the one or more client devices regarding holdings of the user account associated with one or more keywords received from the at least one client device.

9. The system of claim 8, wherein the one or more client devices is electronically accessible to the fund system via a computer network.

10. The system of claim 9, wherein the computer network is at least one of a WAN, a LAN, Internet, wireless communications connection, satellite communications connection, and distributed application server.

11. The system of claim 8, wherein the microprocessor is configured to send a representation of an electronic sheet that has at least one of: a search field, a filter field, a name of one or more holdings having the one or more keywords, a name of one or more investment funds, an identifying number of one or more investment funds, a category of the one or more holdings, an indicator of a percentage of one or more holdings in one or more investment funds, an indicator of a percentage of a user portfolio in one or more holdings, an indicator of a balance of the user account in one or more investment funds, an indicator of a weighted balance of the user account in one or more holdings, an account name indicator associated with one or more holdings, and a currency indicator associated with one or more holdings.

12. A system for searching one or more holdings in one or more investment funds available from an investment bank and accessible by a user, comprising:
a fund system, accessible by one or more client devices, wherein the fund system includes a microprocessor; and
a database electronically connected to said fund system;
wherein the microprocessor is configured to run a computer program, stored in a non-transitory computer-readable storage medium, that instructs the microprocessor to access information resident in the database associated with the one or more investment funds and send information to the one or more client devices regarding holdings of the one or more investment funds.

13. The system of claim 12, wherein the one or more client devices is electronically accessible to the fund system via a computer network.

14. The system of claim 13, wherein the computer network is at least one of a WAN, a LAN, Internet, wireless communications connection, satellite communications connection, and distributed application server.

15. The system of claim 12, wherein the microprocessor is configured to send a representation of an electronic sheet that has at least one of: a filter field for a selected investment fund, a name of one or more holdings associated with the selected investment fund, a category associated with the one or more holdings of the selected investment fund, an indicator of a percentage that one or more holdings have in the selected fund, an indicator of a weighted balance of a portfolio that is in one or more holdings, an account name indicator associated with one or more holdings, and a currency indicator associated with one or more holdings.
